(19) United States
(12) Patent Application Publication
(10) Pub. No.: US 2010/0138010 A1
(43) Pub. Date: Jun. 3, 2010

(54) AUTOMATIC GATHERING STRATEGY FOR UNSUPERVISED SOURCE SEPARATION ALGORITHMS

(75) Inventors: Si Mohamed Aziz Sbai, Fontenay aux roses (FR); Raphael Blouet, St Ouen (FR); Antoine Liutkus, Paris (FR)

Correspondence Address: Mist Technologies SA, 204 rue de Crimee, Paris, 75019, FR

(73) Assignee: AUDIONAMIX, NEW YORK, NY (US)

(21) Appl. No.: 12/349,496

(22) Filed: Jan. 6, 2009

Related U.S. Application Data
(60) Provisional application No. 61/118,491, filed on Nov. 28, 2008.

(51) Int. Cl. G06F 17/00

(52) U.S. Cl. 700/94

(57) ABSTRACT

Unsupervised learning algorithms for audio source separation such as non-negative matrix factorization (NMF) and principal components analysis (PCA) can be understood as a data matrix factorization subject to different constraints. These algorithms provide components with a relevant structure and homogeneous musical events. The invention presents an automatic fusion method to merge these components into tracks associated to the different instruments present in the sound source.

### REFERENCE TO RELATED APPLICATIONS

This application claims an invention which was disclosed in Provisional Application No. 61/118,491, filed 28 Nov. 2008 entitled “AUTOMATIC GATHERING STRATEGY FOR UNSUPERVISED SOURCE SEPARATION ALGORITHMS”. The benefit under 35 USC §119(e) of the United States provisional application is hereby claimed, and the aforementioned application is hereby incorporated herein by reference.

### FIELD OF THE INVENTION

This invention relates to an apparatus and methods for digital sound engineering, more specifically this invention relates to an apparatus and methods for automatic gathering strategy of an unsupervised source separation system.

### BACKGROUND

Non-negative matrix factorization (NMF) is a known method that allows unsupervised source separation. For example, NMF was introduced by Paatero and Tapper. See “Positive matrix factorization: a nonnegative factor model with optimal utilization of error estimates of data values”, Environmetrics, vol. 5, no. 2, pp. 111-126, 1994, hereinafter referred to merely as Paatero and Tapper and hereby incorporated herein by reference.

NMF was popularized by the simple multiplicative update rules of Lee and Seung. See D. D. Lee and H. S. Seung, “Algorithms for nonnegative matrix factorization”, in Advances in Neural Information Processing Systems 13, pp. 556-562, Denver, Colo. USA, 2000, hereinafter referred to merely as Lee and Seung and hereby incorporated herein by reference.

NMF has found a variety of real world applications in the areas such as pattern recognition see D. D. Lee and H. S. Seung, “Learning the parts of objects by nonnegative matrix factorization”, Nature, vol. 401, no. 6755, pp. 788-791, 1999, hereinafter referred to merely as Lee and Seung II and hereby incorporated herein by reference. NMF is also found in other real world applications as in blind source separation, see A. Cichocki, R. Zdunek, and S. Amari, “New algorithms for nonnegative matrix factorization in applications to blind source separation”, 2006 IEEE International Conference on Acoustics, Speech, and Signal Processing, ICASSP2006, Toulouse, France, 2006, hereinafter referred to merely as Zdunek and Amari and hereby incorporated herein by reference.

When applied on an audio signal, NMF system allows to split a mixture of complex audio components in many elementary components. Complex audio component refers to audio class such as musical instruments. Elementary audio component refers to lower level audio class such as musical note. In order, to recover separated audio track at a musical instrument level, there is a need for an automatic fusion method to merge the elementary components into tracks associated to the different instruments present in the sound source.

### SUMMARY OF THE INVENTION

There is provided a novel apparatus and methods for automatic gathering strategy of an unsupervised source separation.

There is provided a novel automatic fusion method to merge components into tracks associated to the different instruments present in the sound source.

A method is provided that comprises: using elementary components provided by a source separation system (SSS) based on non-negative matrix factorization (NMF) or other unsupervised source separation systems; and forming a set of tracks associated with a set of different instruments present in a polyphonic signal.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an example of a source separation system in accordance with the present invention.

FIG. 2 is an example of a flowchart in accordance with the present invention.

FIG. 3 is an example of a system in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to signal processing. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Unsupervised learning algorithms for audio source separation such as non-negative matrix factorization (NMF) and principal components analysis (PCA) can be understood as a data matrix factorization subject to different constraints. These algorithms provide elementary components with a relevant structure and homogeneous musical events. The invention presents an automatic fusion method to merge these components into tracks associated to the different instruments present in the sound source.

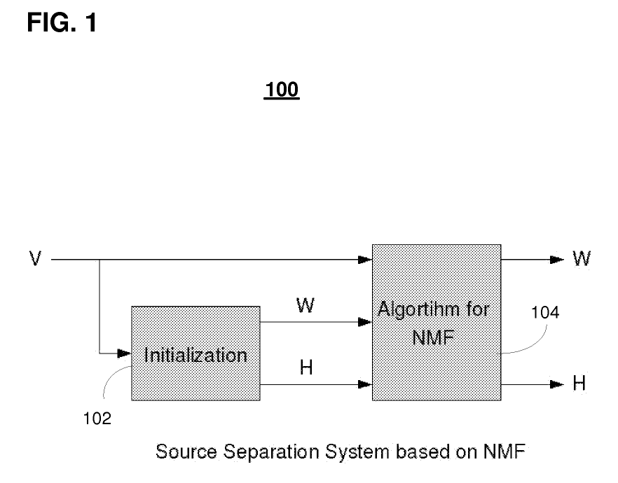

Referring to FIG. 1, a source separation system (SSS) 100 based on non-negative matrix factorization (NMF) is shown. NMF was introduced by Paatero and Tapper but highly popularized by the simple multiplicative update rules of Lee and Seung. NMF has found a variety of real world applications in the areas such as pattern recognition, see Lee and Seung II; and blind source separation, see Zdunek and Amari. Roughly, source separation system (SSS) based on NMF comprises two main steps: first, initialization 102 of NMF. The most used initialization is to estimate the number of true components by Singular Value Decomposition (SVD) or Principal Component Analysis (PCA) and randomly generate matrices. A second method of initialization uses Non-Negative Double Singular Value Decomposition (NNDSVD), see C. Boutsidis and E. Gallopoulos, “SVD based initialization: a head start for nonnegative matrix factorization”, Pattern recognition, 2008, hereinafter merely referred to as Boutsidis and Gallopoulos and hereby incorporated herein by reference. Secondly, the algorithm block 104 method. Various known Algorithms are used for NMF. For example, several algorithms are used for NMF in applications to facilitate blind source separation are proposed in Zdunek and Amari. Furthermore, the V, W and H are values that depend on a specific application thereby may have different interpretations. In our case, the values represent the magnitude spectrum, spectrum basis, and weighted matrix respectively.

In polyphonic music separation a weakness exists in that the system aims to separate audio signals into elementary components, which may not necessarily correspond to the different instruments present in the mixture or source. Indeed, these tracks are characterized by the pitch, so an instrument's multi-pitch may be split into several tracks. Therefore, it is desirable to have the input as elementary components provided by the SSS based on NMF (or other unsupervised source separation system). For the output, tracks are associated respectively with the different instruments present in the polyphonic signal.

The present invention, based on a similarity method taking the pitch effect off, is adapted to estimate the number of true components corresponding to the number of instruments in the sound, and merges contributions of the same instrument.

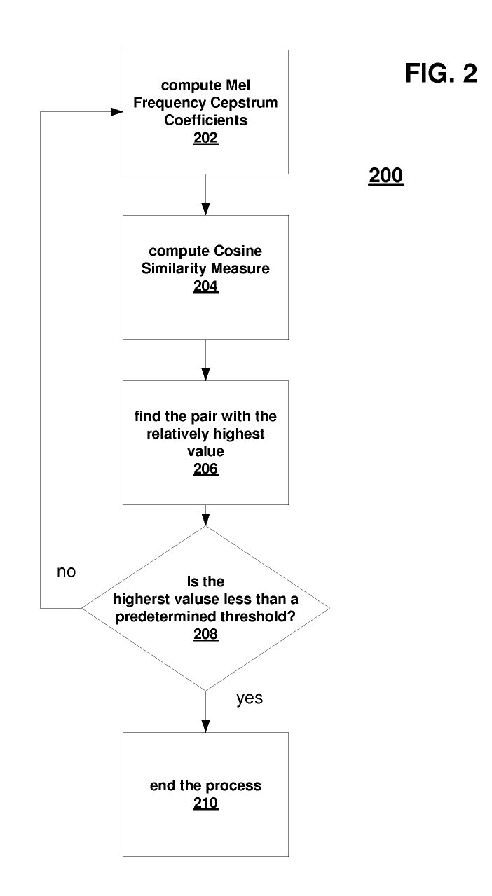

Referring to FIG. 2, a flowchart 200 of the present invention is shown. Mel Frequency Cepstrum Coefficients (MFCC) of each elementary spectrum base are computed (Step 202). This operation is a projection of the elementary spectrum vector in the cepstral space. For each pair of components, the Cosine Similarity Measure (CSM) is computed between their respective MFCC (Step 204). The pair of components with the highest value in the cepstral space is then considered similar and the two components are merged. In other words, find the pair with the highest value and merge the two corresponding components. This way, a new component is obtained (Step 206). Determine whether a certain threshold is reached (Step 208). In other words, a determination is made as to whether the number of components is less than a predetermined number or value. The threshold denotes the number of components. If the threshold is not reached, revert back to Step 202. Otherwise, use the result as the final components (Step 212).

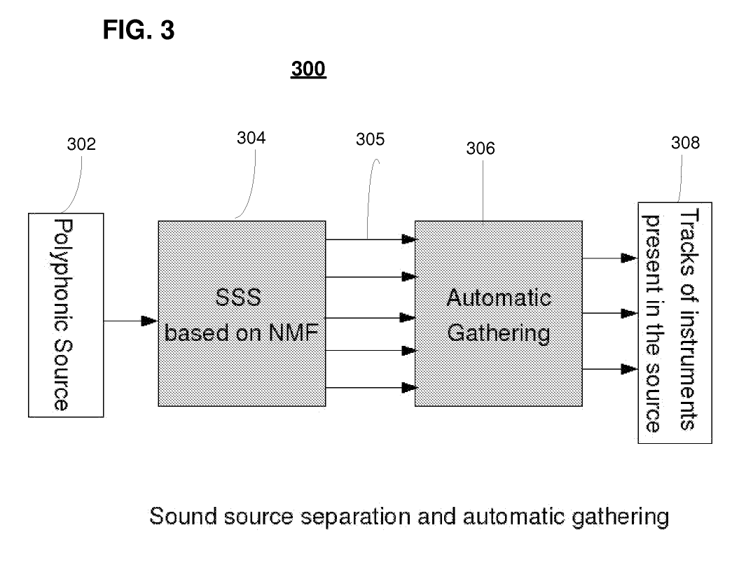

Referring to FIG. 3, a system 300 in accordance with the present invention is shown. Signals from polyphonic source 302 are provided as input. The input is subjected to block 304 wherein the source separation system of FIG. 1 based on non-negative matrix factorization (NMF) is applied. The output 305 of block 304 is further subjected to an automatic gathering block 306 into tracks 308 of instruments present in the source.

Some of the embodiments are described herein as a method or combination of elements of a method that can be implemented by a processor of a computer system or by other means of carrying out the function of the present invention. Thus, a processor with the necessary instructions for carrying out such a method or element of a method forms a means for carrying out the method or element of a method associated with the present invention. Furthermore, an element described herein of an apparatus embodiment is an example of a means for carrying out the function performed by the element for the purpose of carrying out the invention. It will be understood that the steps of methods discussed are performed in one embodiment by an appropriate processor (or processors) of a processing (i.e., computer) system executing instructions stored in a storage. The term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors. It will also be understood that embodiments of the present invention are not limited to any particular implementation or programming technique and that the invention may be implemented using any appropriate techniques for implementing the functionality described herein. Furthermore, embodiments are not limited to any particular programming language or operating system.

The methodologies described herein are, in one embodiment, performable by one or more processors that accept computer-readable (also called machine-readable) logic encoded on one or more computer-readable media containing a set of instructions that when executed by one or more of the processors carry out at least one of the methods described herein. Any processor capable of executing a set of instructions (sequential or otherwise) that performs the functions or actions to be taken are contemplated by the present invention. Thus, one example is a typical processing system that includes one or more processors. Each processor may include one or more of a CPU, a graphics processing unit, or a programmable digital signal processing (DSP) unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display or any suitable display for a hand held device. If manual data entry is required, the processing system also includes an input device such as one or more of an alphanumeric input unit such as a keyboard, a pointing control device such as a mouse, stylus, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries logic (e.g., software) including a set of instructions to cause performing, when executed by one or more processors, one of more of the methods described herein. The software may reside in the hard disk, or may also reside, completely or at least partially, within the RAM and/or within the processor during execution thereof by the computer system. Thus, the memory and the processor also constitute computer-readable carrier medium on which is encoded logic, e.g., in the form of instructions.

Thus, one embodiment of each of the methods described herein is in the form of a computer-readable carrier medium carrying a set of instructions, e.g., a computer program that are for execution on one or more processors, e.g., one or more processors that are part of a communication network. Thus, as will be appreciated by those skilled in the art, embodiments of the present invention may be embodied as a method, an apparatus such as a data processing system, or a computer-readable carrier medium, e.g., a computer program product. The computer-readable carrier medium carries logic including a set of instructions that when executed on one or more processors cause the processor or processors to implement a method. Accordingly, the present invention may take the form of a method, an entirely hardware embodiment, an entirely software embodiment or an embodiment combining software and hardware. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, (i) in one set of embodiment, a tangible computer-readable medium, e.g., a solid-state memory, or a computer software product encoded in computer-readable optical or magnetic media; (ii) in a different set of embodiments, a medium bearing a propagated signal detectable by at least one processor of one or more processors and representing a set of instructions that when executed implement a method; (iii) in a different set of embodiments, a carrier wave bearing a propagated signal detectable by at least one processor of the one or more processors and representing the set of instructions a propagated signal and representing the set of instructions; (iv) in a different set of embodiments, a transmission medium in a network bearing a propagated signal detectable by at least one processor of the one or more processors and representing the set of instructions.

In the foregoing specification, specific embodiments of the present invention have been described. However, one of ordinary skill in the art appreciates that various modifications and changes can be made without departing from the scope of the present invention as set forth in the claims below. For example, the therapeutic light source and the massage component are not limited to the presently disclosed forms. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method comprising:
using elementary components provided by a source separation system (SSS) based on non-negative matrix factorization (NMF) or other unsupervised source separation systems; and
forming a set of tracks associated with a set of different instruments present in a polyphonic signal.

2. The method of claim 1, wherein Mel Frequency Cepstrum Coefficients (MFCC) of each elementary spectrum base is computed.

3. The method of claim 1, wherein, for each pair of components, Cosine Similarity Measure (CSM) is computed between their MFCC.

4. The method of claim 1, wherein a pair of components with the highest similarity value in the cepstral space is considered similar and merged in a new component.

5. The method of claim 1, wherein a process is repeated until a certain similarity threshold is reached.

6. The method of claim 1, wherein a process is repeated until a certain number of component, specified by the user, is reached.

7. The method of claim 1, wherein a number of true components corresponding to the number of instruments in a sound source is computed or estimated.

8. The method of claim 1 contributions of an instrument is Merged.

9. The method of claim 1, wherein each of the set of tracks is associated with a specific track.
